(19) United States
(12) Patent Application Publication
(10) Pub. No.: US 2015/0158397 A1
(43) Pub. Date: Jun. 11, 2015

(54) Method and Apparatus for Predicting Electric Vehicle Energy Consumption

(71) Applicant: Ford Global Technologies, LLC, Dearborn, MI (US)

(72) Inventors: Ciro Angel Soto, Ann Arbor, MI (US); Sujith Rapolu, West Palm Beach, FL (US); Oleg Yurievitch Gusikhin, West Bloomfield, MI (US); Perry Robinson MacNeille, Lathrup Village, MI (US); David Richens Brigham, Ann Arbor, MI (US); Poyu Tsou, Canton, MI (US); Mark John Jennings, Saline, MI (US); Yan Meng, Ann Arbor, MI (US)

(73) Assignee: Ford Global Technologies, LLC, Dearborn, MI (US)

(21) Appl. No.: 14/097,334

(22) Filed: Dec. 5, 2013

(51) Int. Cl. B60L 15/20; B60L 3/12; B60L 11/18

(52) U.S. Cl. CPC B60L 15/2045; B60L 11/1862; B60L 3/12; Y10S 903/903

(57) ABSTRACT

A system includes one or more processors configured to receive a route and receive power-usage-affecting variables. The processor(s) are further configured to break the route into a number of segments. For each segment, the processors are configured to lookup a predetermined power usage estimate, based on the received variables. Also, the processors are configured to present total estimated power usage over the route based on accumulated power usage estimates for each segment.

### TECHNICAL FIELD

The illustrative embodiments generally relate to a method and apparatus for predicting electric vehicle energy consumption.

### BACKGROUND

Electric vehicles are gaining popularity as environmentally friendly, fuel-economic means of transportation. Running on a mix of fuel and electric power, in the case of hybrid electric vehicles (HEVs) or purely on electric power, in the case of battery electric vehicles (BEVs), these vehicles provide an alternative to traditional gasoline powered vehicles. Often times, these vehicles can be charged at a home outlet. In other cases, they can be charged at remote power stations, which are the electric equivalents to traditional gas stations.

Currently, there are only a limited number of remote power stations available for charging electric vehicles (EVs). As the number of EVs on the roads grows, the number of stations is anticipated to grow as well. But, since stations are currently limited in number, drivers need to be a little more cautious about running out of power in a remote location. Knowing how much power will be consumed during a drive can assist in the driver ensuring that a no-power state is avoided.

U.S. Pat. No. 5,487,002 generally relates to an energy management control system employing sensors for monitoring of energy consumption by various vehicle systems and providing energy consumption prediction for range calculation based on standard or memorized driving data. A navigation system in cooperation with the energy management system allows route planning based on energy consumption considerations and provides alternative routes for energy deficient conditions. A controller in the system with an associated display provides information to a vehicle driver concerning system status and controls various vehicle systems for increased energy efficiency.

U.S. Patent Pub. No. 2010/0138142 generally relates to a system embedded in a vehicle including several inputs. The inputs may include one hard coded data, data from sensors on the vehicle, data from external sensors, user coded data, data received from remote databases, data received from broadcast data steams or data that has been accumulated during use of the vehicle. The inputs provide information regarding vehicle speed, motor rpm, motor torque, battery voltage, battery current, and battery charge level, etc. The embedded system also includes a processor unit that receives information from the plurality of inputs and calculates at least an expected vehicle range. The result of any calculations completed by the processing unit is supplied as an output to a display unit, which then displays the information to the user.

U.S. Patent Pub. No. 2011/0270486 generally relates to a system, method and computer program for simulating vehicle energy use. The system comprises a server, an energy modeling tool is linked to a server and generates energy consumption data that provides an energy consumption function of a vehicle under consideration. The data logging tool is linked to test vehicles and collects drive cycle data from real-world driving conditions. The data logging tool then communicates the drive cycle data to the server over a network. The fleet management tool is also linked to the server and combines the energy consumption data with the drive cycle data to estimate the energy use of a vehicle under consideration.

U.S. Patent Pub. No. 2010/0280700 generally relates to balancing vehicle resource load in a shared-vehicle system. A central home-station is provided and allocated a number of vehicles. A number of day-stations are associated with the central home-station with facilities for docking and reenergizing the vehicles. The vehicles are distributed to one or more of the day stations via operation by distribution-users with journeys originating from the central home-station and terminating at the day-stations. The vehicles are provided for limited term use by day-users at the day-stations with a requirement that the vehicles be returned to the day-stations by the end of a respective limited term. The vehicles are returned to the central home-station upon expiration of the limited term use via operation by the distribution-users with journeys originating from the day-stations and terminating at the central home-station.

### SUMMARY

In a first illustrative embodiment, a system includes one or more processors configured to receive a route and receive power-usage-affecting variables. The processor(s) are further configured to break the route into a number of segments. For each segment, the processors are configured to lookup a predetermined power usage estimate, based on the received variables. Also, the processors are configured to present total estimated power usage over the route based on accumulated power usage estimates for each segment.

In a second illustrative embodiment, a computer-implemented method includes receiving a route and receiving power-usage-affecting variables. The method also includes breaking the route into a number of segments, via a vehicle-associated computing system (VACS). The method further includes looking up a predetermined power usage estimate, based on the received variables, for each segment. The method additionally includes presenting total estimated power usage over the route based on accumulated power usage estimates for each segment.

In a third illustrative embodiment, a non-transitory computer readable storage medium stores instructions that, when executed by a processor, cause the processor to perform a method including receiving a route and receiving power-usage-affecting variables.

The method also includes breaking the route into a number of segments, via a vehicle-associated computing system (VACS). The method further includes looking up a predetermined power usage estimate, based on the received variables, for each segment. The method additionally includes presenting total estimated power usage over the route based on accumulated power usage estimates for each segment.

### BRIEF DESCRIPTION OF THE DRAWINGS

FIG. 1 shows an illustrative mapping of maximum regeneration and maximum acceleration on a fixed spacing mesh and a variably spaced mesh;

FIGS. 2A & 2B show illustrative processes for energy consumption calculation adjustment;

FIG. 3 shows an illustrative process for energy consumption calculation over a route and

FIG. 4 shows an illustrative process for adjustment of energy consumption calculation over a route.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Using modeling tools, many factors relating to actual driving conditions can be modeled and observed long before a vehicle is ever driven by a consumer. These modeling tools can also be provided with actual road data to improve modeling accuracy, and the results from the tools can be utilized in real world scenarios with relative confidence.

In the illustrative embodiments, in order to have accessible capability to predict the distance to empty (DTE) in BEVs, energy usage results may be computed in advance using modeling tools, and recorded in a table as shown below. In an illustrative table, elements represent the work needed for locomotion in Watts for a given speed, acceleration, road grade, accessory load and vehicle weight. In this exemplary model, vehicle weight may be simplified and parameterized by the number of passengers in a vehicle, assuming a fixed weight (150 lbs in this case) per passenger. Work may be provided at the battery terminals as well as at the wheels. The former value may include parasitic losses in the powertrain, but not parasitic losses in the battery.

The table may be reduced to separate two dimensional sub-tables for specific accLoads (accessory loads, in Watts) and a number of passengers (columns 4-7 refer to 1-4 passengers, respectively as do columns 8-11 in the table shown). The subtables also have two additional variables, road grade and speed, which, in this model, are the only variables that change during a drive cycle. The sub-tables can then be further reduced to a cubic spline surface dimensioned by % grade and vehicle speed. The values computing by the modeling become the corner nodes for each value in the table. These bicubic spline surfaces may then be used to estimate the power from the drive cycle, with acceleration and grade combined into the % grade value (shown in column 2).

| [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|
| acc_load_Watt | grade_perc | speed_kph | batt_whr | batt_whr | batt_whr | batt_whr | whl_whr | whl_whr | whl_whr | whl_whr |
| 400.000 | −6.00 | 10.0 | −212.72 | −225.22 | −237.70 | −250.20 | −376.63 | −392.66 | −408.67 | −424.70 |
| 400.000 | −6.00 | 30.0 | −288.43 | −302.73 | −317.01 | −331.31 | −354.00 | −369.90 | −385.78 | −401.68 |
| 400.000 | −6.00 | 50.0 | −273.35 | −287.92 | −302.46 | −317.01 | −318.89 | −334.68 | −350.45 | −366.23 |
| 400.000 | −6.00 | 70.0 | −234.25 | −248.99 | −263.60 | −278.22 | −270.65 | −286.35 | −302.01 | −317.68 |
| 400.000 | −6.00 | 90.0 | −177.01 | −191.77 | −206.49 | −221.23 | −208.58 | −224.18 | −239.75 | −255.34 |
| 400.000 | −6.00 | 110.0 | −104.60 | −119.24 | −133.85 | −148.47 | −133.27 | −148.79 | −164.27 | −179.77 |
| 400.000 | −6.00 | 130.0 | −19.74 | −34.20 | −48.60 | −63.02 | −44.44 | −59.90 | −75.31 | −90.74 |
| 400.000 | −4.00 | 10.0 | −96.92 | −104.94 | −112.94 | −120.95 | −229.18 | −239.28 | −249.35 | −259.44 |
| 400.000 | −4.00 | 30.0 | −154.64 | −163.76 | −172.86 | −181.97 | −206.56 | −216.53 | −226.47 | −236.44 |
| 400.000 | −4.00 | 50.0 | −136.31 | −145.50 | −154.66 | −163.83 | −171.46 | −181.32 | −191.15 | −200.99 |
| 400.000 | −4.00 | 70.0 | −95.61 | −104.78 | −113.93 | −123.09 | −123.23 | −132.99 | −142.71 | −152.46 |
| 400.000 | −4.00 | 90.0 | −37.60 | −46.74 | −55.85 | −64.97 | −61.17 | −70.84 | −80.47 | −90.12 |
| 400.000 | −4.00 | 110.0 | 36.10 | 25.94 | 16.41 | 7.38 | 14.14 | 4.55 | −5.00 | −14.56 |
| 400.000 | −4.00 | 130.0 | 131.83 | 121.66 | 111.53 | 101.38 | 102.95 | 93.43 | 83.95 | 74.46 |
| 400.000 | −2.00 | 10.0 | 20.48 | 17.19 | 13.92 | 10.63 | −81.38 | −85.52 | −89.64 | −93.78 |
| 400.000 | −2.00 | 30.0 | −19.47 | −23.15 | −26.80 | −30.47 | −58.77 | −62.78 | −66.78 | −70.79 |

[symbol]

indicates data missing or illegible when filed

The bicubic spline surface may be composed of bicubic patches p(x,y) that may be defined as follows:

p(x,y)=Σᵢ₌₀³Σⱼ₌₀³αᵢⱼxⁱy^{j}

In this equation, the four corners of a patch, where the energy values and their derivatives are known, are defined by x=y=0; x=1, y=0; x=y=1; x=0, y=1. A mapping function maps the velocity into x and the grade/acceleration into y. The mapping function and the coefficients aᵢⱼ for each surface represent the energy performance for an individual vehicle. These can be readily stored on both embedded processors and in cloud-based applications for energy calculations from drive cycles. The 16 coefficients aᵢⱼ may be computed as follows:

For the values computed at the corner of each patch:

p(0,0)=α₀₀

p(1,0)=α₀₀+α₁₀+α₂₀+α₃₀

p(0,1)=α₀₀+α₀₁+α₀₂+α₀₃

p(1,1)=Σᵢ₌₀³Σⱼ₌₀³αᵢⱼ

For the x derivatives computed at the corner of each patch:

$$\frac{\partial p ( 0 , 0 )}{\partial x} = {a}_{10}$$

$$\frac{\partial p ( 1 , 0 )}{\partial x} = {a}_{10} + 2 {a}_{20} + 3 {a}_{30}$$

$$\frac{\partial p ( 0 , 1 )}{\partial x} = {a}_{10} + {a}_{11} + {a}_{12} + {a}_{13}$$

$$\frac{\partial p ( 1 , 1 )}{\partial x} = {\sum }_{i = 0}^{3} {\sum }_{j = 0}^{3} {a}_{ij} i$$

For the y derivatives computed at the corner of each patch:

$$\frac{\partial p ( 0 , 0 )}{\partial y} = {a}_{01}$$

$$\frac{\partial p ( 1 , 0 )}{\partial y} = {a}_{01} + {a}_{11} + {a}_{21} + {a}_{31}$$

$$\frac{\partial p ( 0 , 1 )}{\partial y} = {a}_{01} + 2 {a}_{02} + 3 {a}_{03}$$

$$\frac{\partial p ( 1 , 1 )}{\partial y} = {\sum }_{i = 0}^{3} {\sum }_{j = 0}^{3} {a}_{ij} j$$

For the cross-derivatives of xy at the corners:

$$\frac{\partial ( \frac{\partial p ( 0 , 0 )}{\partial y} )}{\partial x} = {a}_{11}$$

$$\frac{\partial ( \frac{\partial p ( 1 , 0 )}{\partial y} )}{\partial x} = {a}_{01} + {a}_{11} + {a}_{21} + {a}_{31}$$

$$\frac{\partial ( \frac{\partial p ( 0 , 1 )}{\partial y} )}{\partial x} = {a}_{11} + 2 {a}_{02} + 3 {a}_{03}$$

$$\frac{\partial ( \frac{\partial p ( 1 , 1 )}{\partial y} )}{\partial x} = {\sum }_{i = 0}^{3} {\sum }_{j = 0}^{3} {a}_{ij} ij$$

Since there are sixteen aᵢⱼ values and sixteen equations, all the aᵢⱼ can be solved for. This approach provides for short compute time and deterministic solution stability.

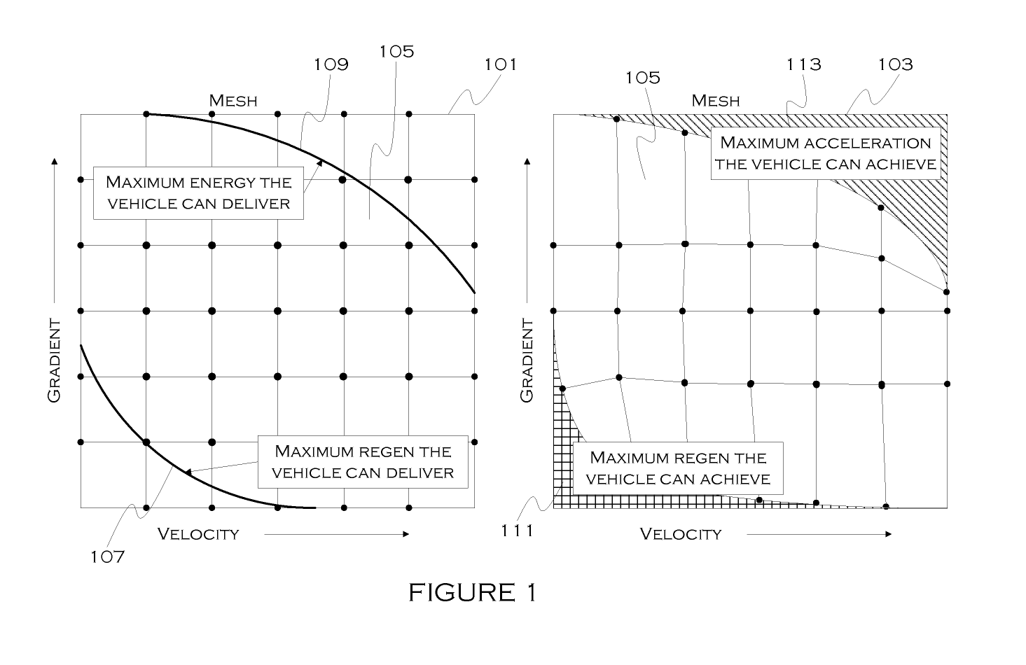

FIG. 1 shows an illustrative mapping of maximum regeneration and maximum acceleration on a fixed spacing mesh and a variably spaced mesh.

The graph 101 represents the mesh of bicubic spline patches on a fixed spacing mesh. This approach may present some difficulty because the energy curve contains first order discontinuities in the % grade and vehicle speed dimensional space at the threshold of maximum acceleration 109 and maximum regeneration 107. Beyond these thresholds, work of locomotion is uniform and represented by a horizontal surface. Within the thresholds 105, the work of locomotion is a smoothly varying function. But, the transition from the smoothly varying function to the horizontal plane is probably not well modeled by a bicubic spline surface on fixed intervals.

A better result can be obtained as shown in 103, by computing the threshold curves, and using a variable interval mesh cubic spline surface with nodes lying on the threshold curve. Here, the maximum acceleration 113 and maximum regeneration 111 have discrete points of intersection defined at the transition between the smooth function and the horizontal surface. In this case, the shape of the regeneration and maximum acceleration threshold curves are fairly well captured.

Other difficulties in modeling may be observed in the lack of hysteresis. The drive cycle data used in the illustrative representations is on one second fixed time intervals, and generally the vehicle speed changes from interval to interval. The model takes several seconds to stabilize after an acceleration/deceleration event, so the work of locomotion is actually a function of the current time interval and several preceding intervals. In addition, there may be longer term temporal effects, such as the vehicle warming up on a cold morning, that may occur over longer periods of time.

Including time effects in the table would require adding dimensions for either higher order derivatives of the velocity curve and/or for the velocity and previous time steps. Doing either would increase the number of simulations needed by order n, although the increase in complexity, memory requirements and computational power for the resulting algorithm are achievable.

Results of the modeling can be stored on a cloud-server or in a vehicle system. If the results are stored remotely, the vehicle may be capable of communication with a server through a remote connection provided by, for example, a WiFi link or a cellular phone in communication with both the vehicle and the remote server.

The vehicle may communicate with the remote server at the inception of a journey, and at various points throughout the journey. If dynamic prediction is enabled (i.e., prediction that varies as variable values change over a route), the system may establish connection whenever a threshold change is notice in a variable, or, for example, whenever a new segment of a route is reached or approached.

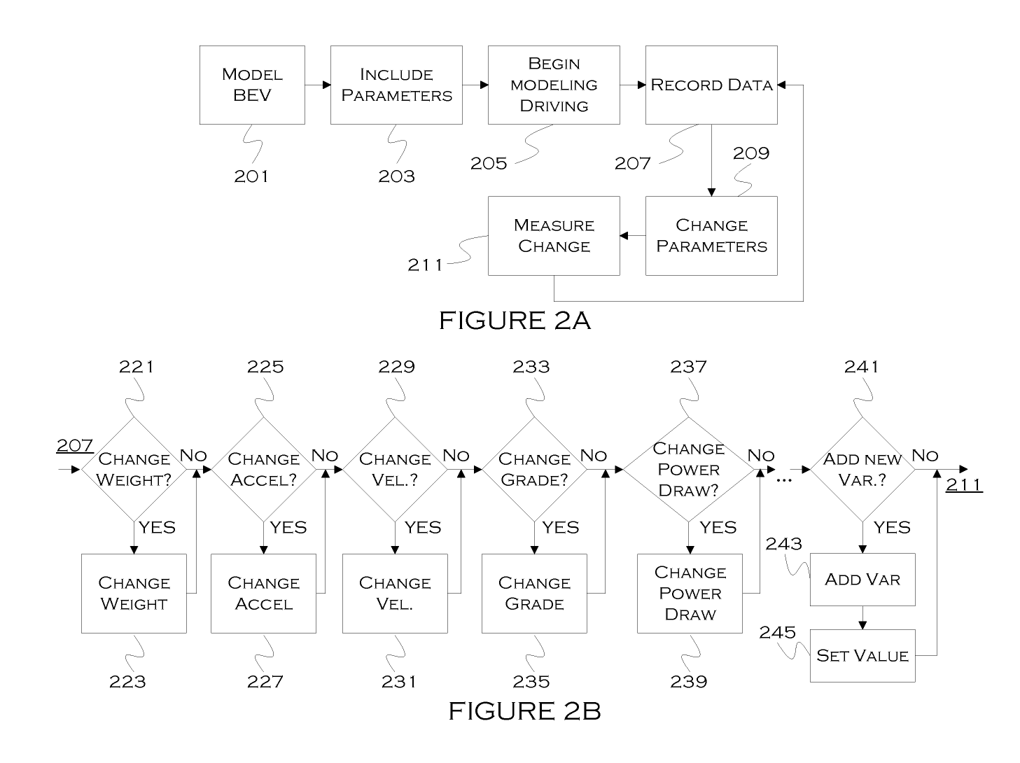

FIG. 2A shows an illustrative process for energy consumption calculation adjustment. In this illustrative example, the process engages in modeling for a particular BEV 201. Parameters, such as, but not limited to, weight, acceleration, grade, velocity and accessory load (draw) can be included in the modeling 203, and the system can simulate a driving experience based on the parameters 205.

Data relating to the power required over intervals can be recorded 207, and changes to the various parameters can be made as needed 209. Effects of the changes can be measured and recorded 211, and the process can continue until all desired changes to parameters have been made. Modeling, as used here, can include solving for a number of known equations using varied parameters.

FIG. 2B shows an illustrative example of possible parameter changes for measuring in modeling cases. Exemplary changes to weight 221, acceleration 225, velocity 229, road grade 233, power draw (e.g., accessory draw) 237 and other, optional variables 241 can be offered for modeling purposes.

Selection of any of these parameters can result in changes, in the model, of the corresponding weight 223, acceleration 227, velocity 231, simulated road grade 235, or power draw 239. Selection of a “new” variable can present the user with an option to add information relating to the new variable 243 and then set of a value corresponding to the new variable 245.

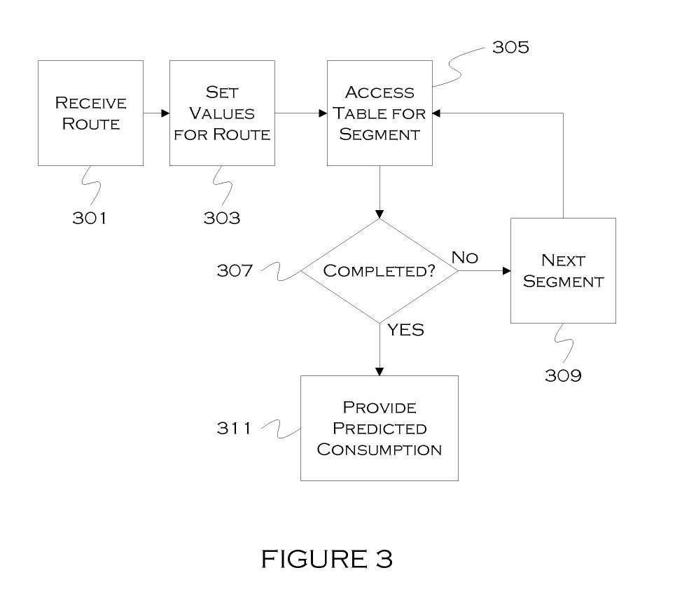

FIG. 3 shows an illustrative process for energy consumption calculation over a route. This exemplary process shows a practical application of the modeling data applied to a vehicle functioning on a road. As previously noted, it is useful for an owner to ensure that the vehicle will likely not run out of power while a trip is in progress. By using the modeled values, estimated power consumption for a known trip can be calculated, and the owner can leave a location with a relative degree of confidence that a current power supply will be sufficient for the journey.

The process then can set the “variables” for the route 303. These can include, for example, but are not limited to, weight (vehicle weight+number of passengers (for example), detected by passenger detection methods), acceleration (assumptions can be made based on known driving profiles, maximum speed limits, traffic over the route, etc.), road grades over the known route, speeds (based on speed limits and traffic, for example), and accessory load (based on temperatures, driver profiles, number of passengers, etc.). Using these variables, the route can be broken into segments (and different values for some variables may be assigned per segment, such as, but not limited to, road grade, acceleration and speed (accessory load and weight should remain relatively constant in this example)) and the table can be accessed for each segment of the route 305. The route can be segmented by time, distance or any other suitable parameter. The energy usage for the segment can be estimated from the table, which, in this example, was calculated in advance.

If there are remaining route segments 307, and the route is not yet completed, the process can continue to calculate power usage over all the remaining segments of the route 309. Once all calculations have been performed, the process may output a predicted power consumption 311 for the entire route.

Since the table is already calculated, if the power usage exceeds the power remaining, the process could also recommend changes to the route that may increase efficiency so that the usage profile fits within the remaining amount of power. Different routes, maximum acceleration rates, accessory limits, etc. can all be recommended so that a power usage profile that will likely use no more than the remaining amount of power is produced. Changes to the variables can be quickly factored into the route, since a simple lookup is all that is required in this example (as opposed to calculating new values). If desired, vehicle active management functions can be engaged as well, that limit acceleration, accessory usage, etc. to a recommended maximum in order to preserve power.

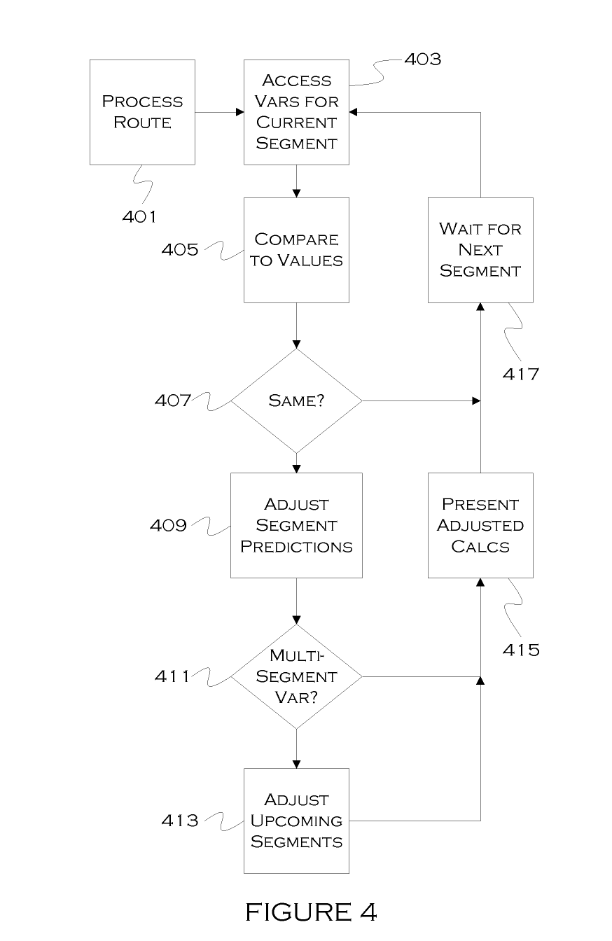

FIG. 4 shows an illustrative process for adjustment of energy consumption calculation over a route. In this illustrative example, the process will dynamically adjust the consumption number as the route progresses. This can help factor in traffic, weight changes (passengers entering or leaving the vehicle, for example), variances in acceleration from a normal profile (e.g., the user is in a hurry), and unexpected accessory loads (e.g., the air conditioning is being run more than expected). Again, in this example, values are drawn from the tables to estimate power usage, so changes to variables can be quickly factored into a route calculation.

In this illustrative example, the system processes the route initially 401 and then accesses variables for each segment as the segment is reached (or sometime prior to reaching the segment) 403. For example, if an unexpected change occurs in any of the variables from the predicted value, the process can recalculate the total usage for the remaining route, based on the new variable value. A common example of this would be a passenger leaving the vehicle.

When a given segment is considered (after the route is underway), the process can compare the current, known values for that segment to the predicted variable values 405. If the known values are close (within a tolerance) or the same as the projected values 407, then there is no need to recalculate the power consumption for that segment, and the process can move to a next segment 417.

If the values have changed, however, the process can adjust the predictions for the current segment 409. Sometimes, a variable may be a multi-segment variable (such as weight, which will presumably apply for all upcoming segments) and sometimes a variable may be better observed on a segment by segment basis (such as grade). In the case of multi-segment variables 411, the process may adjust the variable and accompanying power usage calculations for all upcoming segments when a change in the variable is noticed 413. Since accessing the table (especially if stored in the cloud) may take some finite period of time, it may be beneficial to perform the updates on all upcoming segments when change in a variable likely to remain constant for upcoming segments is noticed.

In the case of a segment such as grade, which should be known in advance, but may unexpectedly change, it may be better to observe changes on a segment by segment basis, as an unexpected change (due to construction, a road change, etc) will not likely populate through all remaining segments of a journey.

After any changes have been calculated, the process can present the new consumption predictions 415 to a driver. Adjustments to driving behavior may also be presented at this time, if projected power consumption has increased above remaining levels of power.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
one or more processors configured to:
receive a route;
receive power-usage-affecting variables and corresponding current and projected values;
break the route into segments;
for each segment, lookup, based on received variable values, a predetermined power usage estimate, predetermined and updated based on crowd-sourced data received corresponding to the same variables having similar values; and
present total estimated power usage over the route based on accumulated power usage estimates for each segment.

2. The system of claim 1, wherein the power-usage-affecting variables include vehicle weight estimates.

3. The system of claim 2, wherein the vehicle weight includes passenger weight estimates.

4. The system of claim 1, wherein the power-usage-affecting variables include speed estimates.

5. The system of claim 1, wherein the power-usage-affecting variables include vehicle accessory usage estimates.

6. The system of claim 1, wherein the power-usage-affecting variables include road grade estimates.

7. The system of claim 1, wherein the power-usage-affecting variables include acceleration estimates.

8. A computer-implemented method comprising:
receiving a route;
receiving power-usage-affecting variables and corresponding current and projected values;
breaking the route into a number of segments, via a vehicle-associated computing system (VACS);
for each segment, looking up, based on received variable values, a predetermined power usage estimate, predetermined and updated based on crowd-sourced data received corresponding to the same variables having similar values; and
presenting total estimated power usage over the route based on accumulated power usage estimates for each segment.

9. The method of claim 8, wherein the power-usage-affecting variables include vehicle weight estimates.

10. The method of claim 9, wherein the vehicle weight includes passenger weight estimates.

11. The method of claim 8, wherein the power-usage-affecting variables include speed estimates.

12. The method of claim 8, wherein the power-usage-affecting variables include vehicle accessory usage estimates.

13. The method of claim 8, wherein the power-usage-affecting variables include road grade estimates.

14. The method of claim 8, wherein the power-usage-affecting variables include acceleration estimates.

15. A non-transitory computer readable storage medium, storing instructions that, when executed by a processor, cause the processor to perform a method comprising:
receiving a route;
receiving power-usage-affecting variables and corresponding current and projected values;
breaking the route into a number of segments, via a vehicle-associated computing system (VACS);
for each segment, looking up, based on received variable values, a predetermined power usage estimate, predetermined and updated based on crowd-sourced data received corresponding to the same variables having similar values; and
presenting total estimated power usage over the route based on accumulated power usage estimates for each segment.

16. The storage medium of claim 15, wherein the power-usage-affecting variables include vehicle weight estimates.

17. The storage medium of claim 15, wherein the power-usage-affecting variables include speed estimates.

18. The storage medium of claim 15, wherein the power-usage-affecting variables include vehicle accessory usage estimates.

19. The storage medium of claim 15, wherein the power-usage-affecting variables include road grade estimates.

20. The storage medium of claim 15, wherein the power-usage-affecting variables include acceleration estimates.
